(19) United States
(12) Patent Application Publication
(10) Pub. No.: US 2002/0125431 A1
(43) Pub. Date: Sep. 12, 2002

(54) Infrared radiation detection device

(76) Inventor: Peter Hwang, Hsinchu (TW)

Correspondence Address: Mathews, Collins, Shepherd & Could, P.A., 100 Thanet Circle, Suite 306, Princeton, NJ, 08540-3674, US

(21) Appl. No.: 09/804,213

(22) Filed: Mar. 12, 2001

(51) Int. Cl. G01J 5/00

(52) U.S. Cl. 250/338.1

(57) ABSTRACT

An infrared radiation detection device is characterized by selecting a material which can be laminated with a thermal process, for example, a plastic-based material such as polyethylene (PE) or polyvinylchloride (PVC), to form the substrate of the infrared radiation device. The infrared radiation detection device combines the phosphors powder and the nonlinear crystal powder as the source for detecting the infrared radiation, thereby the infrared radiation detection device is capable of detecting the infrared radiation at different power level and different visible wavelengths. The active area of the infrared radiation detection device which includes an infrared radiation detection thin film is coated or printed onto the substrate in a margin-to-margin manner, such that the incident infrared radiation glares which is reflected from the surface of the non-active area of the infrared radiation detection device is reduced.

### FIELD OF THE INVENTION

The present invention is directed to a multifunction infrared radiation detection device provided with multiple active areas for detecting an infrared radiation.

### DESCRIPTION OF THE PRIOR ART

As well known in the prior art, the infrared radiation detection device comprises a paper-based substrate and an infrared radiation detection thin film. The infrared radiation detection thin film is coated onto the paper-based substrate and then laminated with the paper-based substrate to serve as an active area provided for detecting the infrared radiation. However, the prior art infrared radiation detection device often reserves a space between the margins of the paper-based substrate and the active area. The space is indispensable because a strong edge bond is required between the paper-based substrate and the infrared radiation detection thin film. As a result, the active area must be retreated a certain distance from the margins of the paper-based substrate in order to forbid the infrared radiation detection device to be delaminated. Nevertheless, when the prior art infrared radiation detection device is taken to detect the infrared radiation, the incident infrared radiation glares will be reflected from the surface of the non-active area of the infrared radiation detection device, which is undesirable in the infrared radiation detection operation.

In the mean time, there are two options in the infrared radiation sensing material provided for forming the infrared radiation detection thin film, namely, nonlinear crystal powder and phosphors powder. Both of the two sensing materials provided for forming the infrared radiation detection thin film have their own advantages and disadvantages. The phosphors powder based infrared radiation detection thin film is applied to detect the infrared radiation at low power level in continuous wavelength, but the detected converted visible radiation beam exhibits widespread beam spots while the visible radiation beam is also rapidly saturated. On the other hand, the nonlinear crystal powder based infrared radiation detection thin film has the advantage of converting the infrared radiation into precise visible radiation beam spots and the converted visible radiation beam will never saturate. Unfortunately, it requires a sufficient peak infrared radiation power in order to sustain the frequency doubling of the incident infrared radiation to visible range.

There arose a need for the applicant to develop an improved infrared radiation detection device, in which the infrared radiation thin film can be formed in a margin-to-margin manner based on either the phosphors powder or nonlinear crystal powder, or the mixture of them, in order that the advantages of the phosphors powder and the nonlinear crystal powder are combined together to enable the infrared radiation detection device to detect the infrared radiation in low frequency and high frequency simultaneously.

### SUMMARY OF THE INVENTION

Consequently, an object of the present invention is to develop an infrared radiation detection device with a simpler manufacturing process.

Another object of the present invention is to develop an infrared radiation detection device for reducing the incident infrared radiation glare which is reflected from the surface of the non-active area of the infrared radiation detection device.

Another yet object of the present invention is to develop an infrared radiation detection device which combines the phosphors powder and the nonlinear crystal powder, or a mixture of them to form the infrared radiation detection thin film of the infrared radiation detection device, in order that the infrared radiation detection device can detect the infrared radiation in low power and in high power simultaneously.

The infrared radiation detection device according to a first preferred embodiment of the present invention includes a substrate, and at least one infrared radiation detection thin film formed on the substrate which is extended from one margin of the substrate to serve as an active area provided for detecting an infrared radiation.

Certainly, the substrate is adapted to be laminated with a thermal process, for example, a plastic-based material such as polyethylene (PE) or polyvinylchloride (PVC). In addition, the infrared radiation thin film comprises a phosphors powder, or a nonlinear crystal powder, or a mixture of them.

The aforesaid infrared radiation detection device further includes a top sheet and a bottom sheet for sandwiching therebetween the substrate and the infrared radiation detection film. The top sheet and the bottom sheet may be formed with the same material as the substrate, for example, a plastic-based material such as PE or PVC.

The present invention also provides a manufacturing process for forming the infrared radiation detection device, including the acts of forming an infrared radiation detection film on a substrate, sandwiching the infrared radiation detection film and the substrate with a top sheet and a bottom sheet, and laminating the top sheet, the infrared radiation detection film, the substrate, and the bottom sheet with a thermal process to form an infrared radiation detection device.

The infrared radiation detection film is formed on the substrate with a coating process or a printing process. Further, before the act of sandwiching the infrared radiation detection film and the substrate with a top sheet and a bottom sheet, the manufacturing process further includes an act of trimming and pasting at least one of the infrared radiation detection film and the substrate to a desired size and shape. After the lamination process, the infrared radiation detection device is further punched to finish the manufacturing process for the infrared radiation detection device.

Now the foregoing and other features and advantages of the present invention will be more clearly understood through the following descriptions with reference to the accompanying drawings, in which:

### BRIEF DESCRIPTION OF THE DRAWINGS

FIG. 1 (a) is a top view of the infrared radiation detection device with single active area provided for detecting the infrared radiation according to the present invention;

FIG. 1 (b) is a top view of the infrared radiation detection device with multiple active areas provided for detecting the infrared radiation according to the present invention; and

FIG. 2 is a cross-sectional view of the infrared radiation detection device illustrating the manufacturing process for the infrared radiation detection device according to the present invention.

### DETAILED DESCRIPTION OF THE PREFERRED EMBODIMENT

The infrared radiation detection device of the present invention will now be described in detail in accordance with the following descriptions in conjunction with drawings. The present invention can be well known and be accomplished by anyone skilled in the related art in light of the following embodiments, but it is to be understood that the exact implementation of the present invention is not able to be limited by the disclosed embodiments.

Unlike the conventional infrared radiation detection device, which selects paper-based material to form the substrate and laminates the paper-based substrate with an infrared radiation detection thin film, the present invention selects a material which is adapted to be laminated with a thermal process, e.g. a plastic-based material such as polyethylene (PE) or polyvinylchloride (PVC), to form the substrate. The plastic-based material is well known in its plasticity under temperature variation, and can be easily laminated with the optical sensing material based thin film.

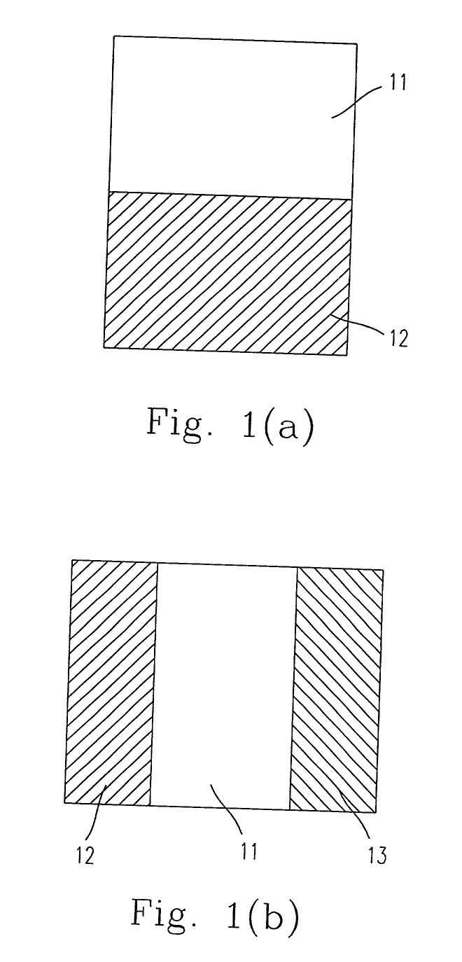

FIG. 1 (a) shows the top view of the infrared radiation detection device of the present invention. As shown in FIG. 1, the infrared radiation detection device includes a substrate 11 and a single active area 12. The substrate 11 comprises a plastic-based material, and the single active area 12 comprises either a phosphors powder based infrared radiation detection thin film or a nonlinear crystal powder based infrared radiation detection thin film, or an infrared radiation detection thin film based on the mixture of the phosphors powder and the nonlinear crystal powder. FIG. 1 (b) shows the top view of the infrared radiation detection device with multiple active areas according to the present invention. In FIG. 1 (b), except for the substrate 11, the infrared radiation detection device includes two active areas, that is, the first active area 12 and the second active area 13. It is worthy to note that the first active area 12 may comprise the phosphors powder based infrared radiation thin film, and the second active area 13 may comprise the nonlinear crystal powder based infrared radiation thin film.

The configuration of the infrared radiation detection device in FIG. 1 (b) allows the infrared radiation in low power at certain visible wavelengths from the phosphors powder and high power infrared radiation at other visible wavelengths from the nonlinear crystal powder to be detected simultaneously. The advantages of using phosphors powder as the source for the infrared radiation detection and using nonlinear crystal power as the source for the infrared radiation detection are combined together in an infrared radiation detection device, whereby an infrared radiation detection device of the present invention can be applied to detect the infrared radiations at different power levels and different visible wavelengths.

Further, another advantage of the present invention can be clearly seen from FIG. 1 (a) and FIG. 1 (b) that the active area provided for detecting the infrared radiation can be extended from one margin of the substrate. The space between the margins of the substrate and the active area is eliminated, such that the incident infrared radiation beam will completely penetrate the infrared radiation detection thin film and the undesirable incident infrared radiation glare will not be reflected from the surface of the non-active area of the infrared radiation detection device.

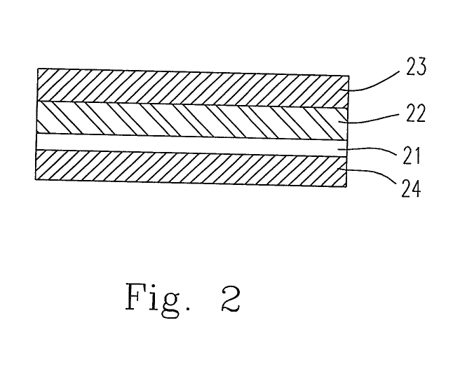

FIG. 2 is a cross-sectional view of the infrared radiation detection device according to the present invention. The manufacturing process for the infrared radiation detection device according to the present invention can be best demonstrated according to FIG. 2 accompanied with the following description. An infrared radiation detection film 22, for example, a phosphors powder based infrared radiation detection thin film or a nonlinear crystal powder based infrared radiation detection thin film, is first coated or printed onto a substrate 21 by using proper solvents. The substrate 21 has the property that it can be laminated under a thermal process, for example, PE or PVC. After the infrared radiation detection thin film 22 is adhered onto the substrate 21, the resulting infrared radiation detection device can be trimmed and pasted to the desired size and shape depending on the design specification. Following the trimming and pasting process is the sandwiching process. The infrared radiation detection film 22 and the substrate 21 are sandwiched between a top sheet 23 and a bottom sheet 24. The top sheet 23 and the bottom sheet 24 may be formed with the same material as the substrate 21, that is, a plastic-based material such as PE or PVC. A lamination process is performed to laminate the substrate 21, the infrared radiation detection film 22, the top sheet 23, and the bottom sheet 24. Further to the lamination process, the laminated infrared radiation detection device shown in FIG. 2 is punched to finish the manufacturing process of the infrared radiation detection device according to the present invention.

According to the above statements, it is to be understood that the infrared radiation detection device substantially overcomes the disadvantages encountered in the prior art and improves the radiation detection effect in some aspects. The infrared radiation detection device according to the present invention selects a material which is adapted to be laminated with a thermal process, such as PE or PVC, to form the substrate instead of the prior art paper-based substrate, such that the infrared radiation detection device of the present invention is manufactured with a simpler process. Furthermore, the active area can be created in a margin-to-margin mariner on the substrate, thereby the incident infrared radiation can completely penetrate the infrared radiation detection thin film and the incident infrared radiation glares generated in the non-active area of the infrared radiation detection device is reduced. Most importantly, the infrared radiation detection device can be equipped with multiple active areas, each of which can be applied to detect the infrared radiation at different power levels and different visible wavelengths. Therefore, the infrared radiation detection device of the present invention is capable of detecting the infrared radiation at different power levels and different visible wavelengths.

Those of skill in the art will recognize that these and other modifications can be made within the spirit and scope of the invention as defined in the appended claims.

I claim:

1. An infrared radiation detection device comprising:
a substrate; and
at least one infrared radiation detection thin film formed on said substrate which is extended from one margin of said substrate to serve as an active area provided for detecting an infrared radiation.

2. The infrared radiation detection device of claim 1 wherein said substrate is adapted to be laminated with a thermal process.

3. The infrared radiation detection device of claim 2 wherein said substrate comprises a plastic-based material.

4. The infrared radiation detection device of claim 3 wherein said plastic-based material comprises one of a polyethylene (PE) and a polyvinylchloride (PVC).

5. The infrared radiation detection device of claim 1 further comprising a top sheet formed above said infrared radiation detection thin film and a bottom sheet formed underneath said substrate.

6. The infrared radiation detection device of claim 5 wherein said top sheet is adapted to be laminated with a thermal process.

7. The infrared radiation detection device of claim 6 wherein said top sheet comprises a plastic-based material.

8. The infrared radiation detection device of claim 7 wherein said plastic-based material comprises one of a polyethylene (PE) and a polyvinylchloride (PVC).

9. The infrared radiation detection device of claim 5 wherein said bottom sheet is adapted to be laminated with a thermal process.

10. The infrared radiation detection device of claim 9 wherein said bottom sheet comprises a plastic-based material.

11. The infrared radiation detection device of claim 10 wherein said plastic-based material comprises one of a polyethylene (PE) and a polyvinylchloride (PVC).

12. The infrared radiation detection device of claim 1 wherein said infrared radiation thin film comprises a phosphors powder.

13. The infrared radiation detection device of claim 1 wherein said infrared radiation thin film comprises a nonlinear crystal powder.

14. The infrared radiation detection device of claim 1 wherein said infrared radiation thin film comprises a mixture of a phosphors powder and a nonlinear crystal powder.

15. A method for manufacturing an infrared radiation detection device, comprising the acts of:
forming an infrared radiation detection film on a substrate;
sandwiching said infrared radiation detection film and said substrate with a top sheet and a bottom sheet; and
laminating said top sheet, said infrared radiation detection film, said substrate, and said bottom sheet to form an infrared radiation detection device.

16. The method of claim 15 wherein said infrared radiation detection film is formed on said substrate with a coating process.

17. The method of claim 15 wherein said infrared radiation detection film is formed on said substrate with a printing process.

18. The method of claim 15 wherein before said act of sandwiching said infrared radiation detection film and said substrate with a top sheet and a bottom sheet, said method further comprising an act of trimming and pasting at least one of said infrared radiation detection film and said substrate to a desired size and shape.

19. The method of claim 15 wherein said act of laminating said top sheet, said infrared radiation detection film, said substrate, and said bottom sheet to form an infrared radiation detection device includes a thermal process.

20. The method of claim 15 further comprising an act of punching said infrared radiation detection device.
